(19) United States
(12) Patent Application Publication
(10) Pub. No.: US 2011/0141068 A1
(43) Pub. Date: Jun. 16, 2011

(54) ADVERTISING KIOSK AND CONTROL METHOD THEREOF

(75) Inventor: LUNG DAI, Tu-Cheng (TW)

(73) Assignee: HON HAI PRECISION INDUSTRY CO., LTD., Tu-Cheng (TW)

(21) Appl. No.: 12/843,177

(22) Filed: Jul. 26, 2010

(30) Foreign Application Priority Data
Dec. 11, 2009 (CN) 200910311260.X

(51) Int. Cl. G06F 3/038

(52) U.S. Cl. 345/204

(57) ABSTRACT

An advertising kiosk includes a detecting unit, a comparing unit, a display unit, a controlling unit. The detecting unit detects whether a person is within proximity of the advertising kiosk and generating a detecting signal. The comparing unit determines whether the detecting signal is at least a predetermined value. If it is determined that the detecting signal is less than the predetermined value, nobody is within proximity of the advertising kiosk, and the comparing unit generates a stopping signal. The display unit is used for displaying advertisements, and is capable of alternating between a display state and standby state. The controlling unit responds to the stopping signal to detect whether the display unit is in the display state, and disables the display unit to stop displaying advertisements when the display unit is in the display state.

### BACKGROUND

1. Technical Field

The present disclosure relates to electronic devices; and particularly to an advertising kiosk and a control method used by the advertising kiosk.

2. Description of Related Art

An advertising kiosk in a public place always displays advertisements, even if nobody views the displayed advertisements. This is a waste of energy.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of an advertising kiosk in accordance with one exemplary embodiment.

FIG. 2 is a flow chart of a display control method in accordance with another exemplary embodiment.

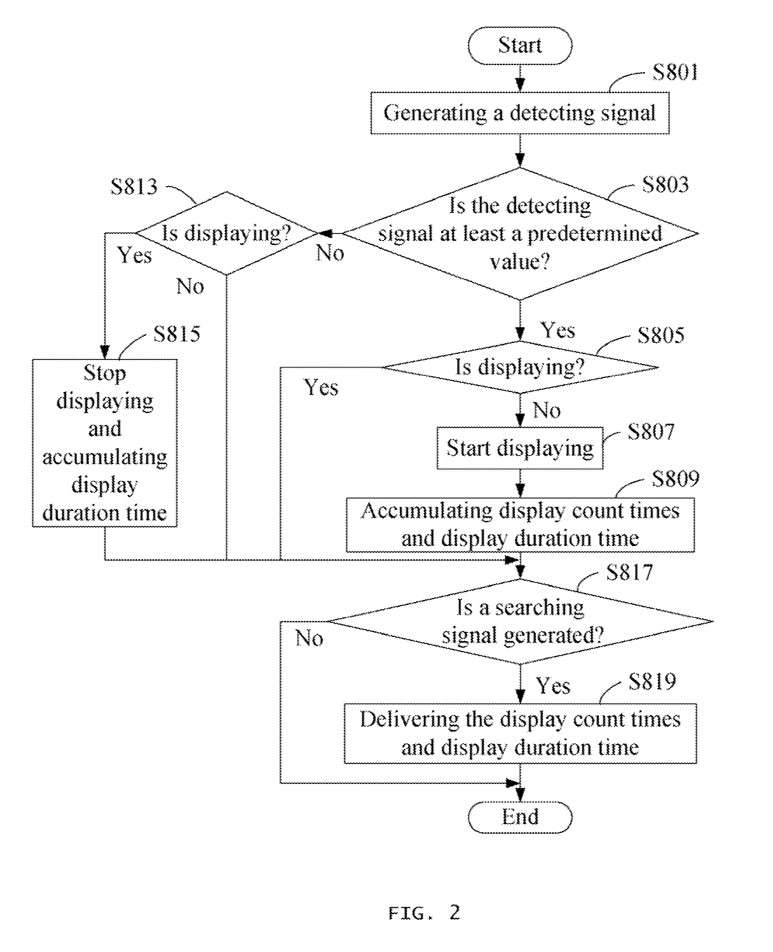

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

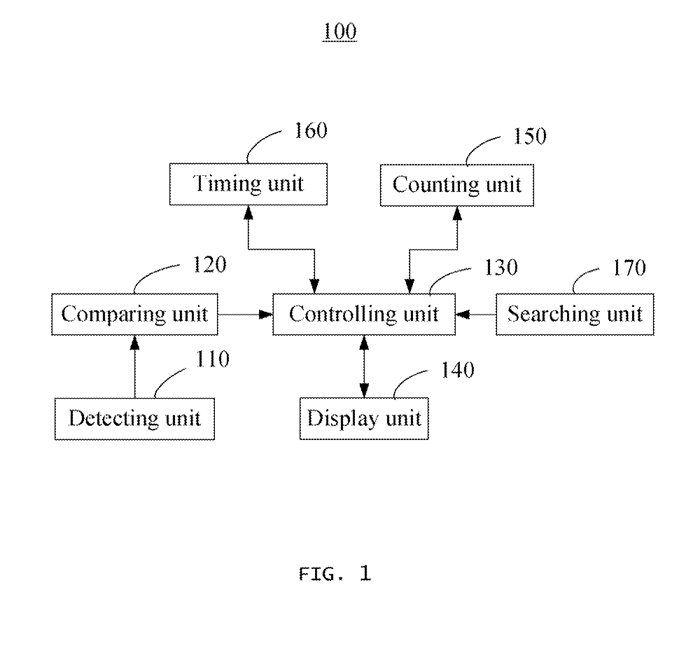

Referring to FIG. 1, an advertising kiosk 100 in a public place includes a detecting unit 110, a comparing unit 120, a controlling unit 130, a display unit 140, a counting unit 150, a timing unit 160, and a searching unit 170. The public place may be a public toilet.

The detecting unit 110 is used for detecting whether a person is within proximity of the advertising kiosk 100, and generating a detecting signal. The detecting unit 110 may be an infrared sensor that detects whether the person is within proximity of the advertising kiosk 100 by detecting heat generated within a detecting area.

The comparing unit 120 is used for determining whether the detecting signal is at least a predetermined value and generating a comparing result. If it is determined that the detecting signal is at least the predetermined value, the person is within proximity of the advertising kiosk 100, and the comparing unit 120 generates a continue display signal. If it is determined that the detecting signal is less than the predetermined value, nobody is within proximity of the advertising kiosk 100, and the comparing unit 120 generates a stopping signal.

The display unit 140 is used for displaying advertisements. The display unit 140 is capable of alternating between a display state and a standby state.

The controlling unit 130 is used for responding to the continue display signal to detect whether the display unit 140 is in the standby state, and controlling the display unit 140 to start displaying advertisements when the display unit 140 is in the standby state, meanwhile, the controlling unit 130 starts the counting unit 150 and the timing unit 160 to accumulate display count times and display duration time of the advertising kiosk 100 respectively. The display count times herein is the number of times that the display unit 140 turns on to display, and the display duration time herein is the length of time the display unit 140 displays each of those display count times.

The controlling unit 130 is further used for responding to the stopping signal to detect whether the display unit 140 is in the display state, and disable the display unit 140 so that the display unit 140 stops displaying advertisements when the display unit 140 is in the display state, meanwhile, the controlling unit 130 controls the timing unit 160 to stop timing. As such, the display unit 140 displays advertisements only under the condition that a person is within proximity of the advertising kiosk. Therefore, the display unit 140 does not display when there is no one around, avoiding the waste of electricity common in devices which continually display nonstop.

The searching unit 170 is used for generating a searching signal in response to user's operations. The searching unit 170 may be a button arranged on the advertising kiosk 100, and the searching signal is generated when the button is pressed. If the advertising kiosk 100 has a display function, the searching unit 170 may be a menu item displayed by the advertising kiosk 100, and the searching signal is generated when the menu item is selected.

The controlling unit 130 is further used for controlling the display unit 140 to deliver the display count times accumulated by the counting unit 150, and the display duration time accumulated by the timing unit 160 in response to the searching signal. As such, the display count times and display duration time can be used for determining whether the advertising kiosk 100 is located in an appropriate location.

In other embodiments, the searching unit 170 can be omitted, the controlling unit 130 controls the display unit 140 to deliver the play count times accumulated by the counting unit 150, and the display duration time accumulated by the timing unit 160 in real-time.

A display control method is used to control an advertising kiosk in a public place to display advertisements. The public place may be a public toilet. The display control method includes the following steps.

In step S801, generating a detecting signal for determining whether a person is within proximity of the advertising kiosk. In the embodiment, whether the person is within proximity of the advertising kiosk by detecting heat generated within a detecting area via an infrared sensor.

In step S803, determining whether the detecting signal is at least a predetermined value. If it is determined that the detecting signal is at least the predetermined value, the person is within proximity of the advertising kiosk, and step S805 is implemented. If it is determined that the detecting signal is less than the predetermined value, nobody is within proximity of the advertising kiosk, and step S813 is implemented.

In step S805, detecting whether the advertising kiosk is displaying. If it is determined that the advertising kiosk is not displaying, step S807 is implemented. If it is determined that the advertising kiosk is displaying, step S817 is implemented.

In step S807, controlling the advertising kiosk to start displaying advertisements, and then step S809 is implemented.

In step S809, accumulating display count times and display duration time of the advertising kiosk, and then step S817 is implemented. The display count times herein is the number of times that the advertising kiosk turns on to display, and the display duration time herein is the length of time the advertising kiosk displays each of those display count times.

In step S813, determining whether the advertising kiosk is displaying. If it is determined that the advertising kiosk is displaying, step S815 is implemented. If it is determined that the advertising kiosk is not displaying, step S817 is implemented.

In step S815, controlling the advertising kiosk to stop displaying advertisements, and stop accumulating the display duration time, and step S817 is implemented.

In step S817, determining whether the searching signal is generated. If it is determined that the searching signal is generated, step S819 is implemented. If it is determined that the searching signal is not generated, the procedure is ended. In the embodiment, the advertising kiosk has a button, and the searching signal is generated when the button is pressed.

In step S819, delivering the accumulated display count times and display duration time. As such, the display count times and display duration time can be used for determining whether the advertising kiosk is located in an appropriate location.

Using the above energy-saving display control method, the advertising kiosk displays advertisements only under the condition that a person is within proximity of the advertising kiosk.

It is to be understood, even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. An advertising kiosk, comprising:
a detecting unit adapted to detect whether a person is within proximity of the advertising kiosk and generate a detecting signal;
a comparing unit adapted to determine whether the detecting signal is at least a predetermined value; wherein if it is determined that the detecting signal is at least the predetermined value, the person is within proximity of the advertising kiosk, and the comparing unit is further adapted to generate a continue display signal; wherein if it is determined that the detecting signal is less than the predetermined value, nobody is within proximity of the advertising kiosk, and the comparing unit is further adapted to generate a stopping signal;
a display unit adapted to display advertisements, the display unit capable of alternating between a display state and a standby state; and
a controlling unit adapted to respond to the continue display signal to detect whether the display unit is in the standby state, and control the display unit to start displaying advertisements when the display unit is in the standby state; the controlling unit further adapted to respond to the stopping signal to detect whether the display unit is in the display state, and disable the display unit to stop displaying advertisements when the display unit is in the display state.

2. The advertising kiosk according to claim 1, further comprising a timing unit, the controlling unit further adapted to control the timing unit to accumulate display duration time when controlling the display unit to start displaying advertisements, and control the timing unit to stop accumulating display duration time when disabling the display unit to stop displaying advertisements; the controlling unit further adapted to control the display unit to deliver the accumulated display duration time.

3. The advertising kiosk according to claim 2, further comprising a searching unit adapted to generate a searching signal in response to user's operations, the controlling unit further responding to the searching signal to deliver the accumulated display duration time.

4. The advertising kiosk according to claim 1, further comprising a counting unit, the controlling unit further adapted to control the counting unit to accumulate display count times when controlling the display unit to start displaying advertisements; the controlling unit further adapted to control the display unit to deliver the accumulated display count times.

5. The advertising kiosk according to claim 4, further comprising a searching unit adapted to generate a searching signal in response to user's operations, the controlling unit further responding to the searching signal to deliver the accumulated display count times.

6. The advertising kiosk according to claim 1, wherein the detecting unit detects whether a person is within proximity of the advertising kiosk by detecting heat generated within a detecting area.

7. The advertising kiosk according to claim 6, wherein the detecting unit is an infrared sensor.

8. A display control method adapted to control an advertising kiosk to display advertisements, the display control method comprising:
generating a detecting signal for determining whether a person is within proximity of the advertising kiosk;
if it is determined that the detecting signal is at least a predetermined value, the person is within proximity of the advertising kiosk, and determining whether the advertising kiosk is displaying;
if the advertising kiosk is not displaying, controlling the advertising kiosk to start displaying advertisements;
if it is determined that the detecting signal is less that the predetermined value, nobody is within proximity of the advertising kiosk, and determining whether the advertising kiosk is displaying; and
if the advertising kiosk is displaying, controlling the advertising kiosk to stop displaying advertisements.

9. The method according to claim 8, wherein whether a person is within proximity of the advertising kiosk is detected by detecting whether heat generated within a detecting area.

10. The method according to claim 8, further comprising steps of accumulating display duration time of the advertising kiosk and delivering the display duration time after the step that if the advertising kiosk is not displaying, controlling the advertising kiosk to start displaying advertisements, and further comprising steps of stopping accumulating the display duration time and delivering the display duration time after the step that if the advertising kiosk is displaying, controlling the advertising kiosk to stop displaying advertisements.

11. The method according to claim 10, further comprising step of determining whether a searching signal is generated between the step of accumulating display duration time of the advertising kiosk and the step of delivering the display duration time; and wherein if the searching signal is generated, the step of delivering the display duration time is implemented.

12. The method according to claim 10, further comprising step of determining whether a searching signal is generated between the step of stopping accumulating display duration time of the advertising kiosk and the step of delivering the display duration time; and wherein if the searching signal is generated, the step of delivering the display duration time is implemented.

13. The method according to claim 8, further comprising steps of accumulating display count times of the advertising kiosk, and delivering the display count times after the step that if the advertising kiosk is not displaying, controlling the advertising kiosk to start displaying advertisements.

14. The method according to claim 13, further comprising step of determining whether a searching signal is generated between the step of accumulating display count times of the advertising kiosk and the step of delivering the display count times; and wherein if the searching signal is generated, the step of delivering the display count times is implemented.

15. A kiosk for displaying advertisement, the kiosk comprising:
a detector for detecting the proximity of a person to the kiosk;
a display unit;
a timing unit; and
a controlling unit;
wherein when the display unit is in an active state, the controlling unit stops the display unit if no person is detection after a period of time, wherein when the display unit is in a standby state, the controlling unit activates the display unit when a person is detected to be within a predetermined distance from the kiosk, and the timing unit record the display duration time of the display unit.

16. The kiosk according to claim 15, further comprising a counting unit adapted to record the display count times of the display unit.
